(19) United States
(12) Patent Application Publication
(10) Pub. No.: US 2011/0075403 A1
(43) Pub. Date: Mar. 31, 2011

(54) Safety Device For Illuminating Sports Enthusiasts

(76) Inventors: Christopher NIEZRECKI, Merrimack, NH (US); Robert MALLOY, Londonderry, NH (US)

(21) Appl. No.: 12/883,967

(22) Filed: Sep. 16, 2010

Related U.S. Application Data
(60) Provisional application No. 61/243,033, filed on Sep. 16, 2009.

(51) Int. Cl. F21L 4/08; F21L 4/02; B62J 6/02

(52) U.S. Cl. 362/183; 362/184; 362/473

(57) ABSTRACT

Apparatus and methods are provided to illuminate a person engaged in an activity along a dark road, thereby promoting safety. The apparatus may allow approaching traffic, such as motorized vehicles, to see and recognize the presence and speed of the user, reducing the occurrence of collisions. The apparatus includes a light which is positioned in a location and at an angle to improve the illumination of the user, while enabling compact storage when not in use via a preferred telescoping design having means to transfer electrical power through the telescoping member.

### CROSS-REFERENCE TO RELATED APPLICATIONS

This application claims the benefit of U.S. Provisional Application No. 61/243,033, filed Sep. 16, 2009, the teachings of which are incorporated by reference.

### FIELD

The present disclosure relates to a device and method for illuminating individuals involved in sporting activities, and more particularly to a rider on a bicycle, or a runner, on a roadway under poor lighting conditions.

### BACKGROUND

Approximately 1,000 cyclists are killed and an additional 70,000 suffer disabling injuries in accidents with motor vehicles each year in the United States. Approximately 60% of these accidents occur in the dark. Additionally, darkness may cause injuries during many other sporting activities/exercises, such as walking, jogging, and in-line skating, as well as downhill and cross-country skiing, and snowboarding, where night-time events have become increasingly popular in recent years. Children may be especially vulnerable to injury via vehicle collisions. Moreover, these activities may take place in crowded, urban areas. Unfortunately, these sports men and women, and children, may be subject to the inabilities and inattentiveness of persons traveling in vehicles on public roads and ways, as well as each other.

One product now on the market which appears to be directed at this problem includes a red light that shines rearward of the bicyclist and may be only visible from locations which are relatively directly behind the bike. Further, vehicles (such as cars, trucks, motorcycles, scooters, and other vehicles) moving at an angle to the bicyclist may not see the bicyclist until they are relatively close, particularly because reflectors on the bicycle may require direct illumination from a source perpendicular, or nearly perpendicular, to the plane of the reflective surface. Additionally, current commercially available lights may not allow the motor vehicle driver to identify the object as a bicycle, and may therefore underestimate the speed of the bicyclist until it is too late to avoid a collision. Standard bicycle lights, typically mounted behind the saddle, face rearward (or in front of the rider facing forward), are generally mounted relatively low to the rider's position of the bicycle and may be dim, thereby resulting only in illuminating the darkness, or only a relatively small portion (legs) of the bicyclist.

Other lighting designs, primarily electroluminescent lighting systems, may incorporate panels affixed to the bicycle frame for illumination, and may be relatively expensive and cost-prohibitive to many sporting enthusiasts.

Accordingly, there is a need for an improved lighting apparatus and method. Specifically, it would be advantageous to provide more effective safety systems for sporting enthusiasts to use under dim lighting conditions on roadways.

### SUMMARY

An apparatus for illuminating a human, the apparatus comprising a retractable/extendable member having ends, a housing connected to a first end of the member, the housing including one or more light sources which illuminate an area. A power supply is then included for supplying electrical power connected to the member wherein the power supply is in electrical communication with the one or more light sources. Accordingly, when the human has a direction of movement, the member extends opposite the direction of movement of the human, and the light shines in the direction of movement and illuminates an area of the human.

In method form, the present invention relates to a method for illuminating a human or piece of equipment the method comprising providing an apparatus comprising a retractable/extendable member having ends and a housing connected to a first end of the member, the housing including one or more light sources which illuminate an area. One may then supply a power supply for supplying electrical power connected to the member, the power supply in electrical communication with the one or more light sources. It may be appreciated that upon attachment of the apparatus to the piece of equipment and providing power to the apparatus the apparatus illuminates an area of the human and/or the piece of equipment.

### BRIEF DESCRIPTION OF THE DRAWINGS

The features, operation and advantages of the invention may be better understood from the following detailed description of the preferred embodiments taken in conjunction with the attached drawings, in which

FIG. 1 is a perspective view of the lighting apparatus according to the present disclosure;

FIG. 2 is a side view of a bicycle including the lighting apparatus of FIG. 1 in an extended position;

FIG. 3 is a perspective view of a rider on a bicycle illustrating the illumination provided by the lighting apparatus of FIG. 1;

FIG. 4 is a side view of a bicycle including the lighting apparatus of FIG. 1 in a retracted position;

FIG. 5 is a side view of a bicycle including the lighting apparatus of FIG. 1 in a stowed position;

FIG. 6 is a plan view of the battery case of FIG. 1 with the cover removed, as well as a plan view of the lamp housing of FIG. 1 with the cover removed.

### DETAILED DESCRIPTION

Still other objects and advantages of the present invention will become readily apparent to those skilled in the art from the following detailed description, wherein it is shown and described preferred embodiments of the invention. As will be realized the invention is capable of other and different embodiments, and its several details are capable of modification in various respects, without departing from the invention. Accordingly, the description is to be regarded as illustrative in nature and not as restrictive.

The present disclosure provides an apparatus and method for an effective, lightweight, retractable, cost-sensitive light which may illuminate a relatively large area of an individual (rather than an area behind him) or parts of his equipment, such as a bicycle, shirt, pants, hat, etc.

This may then provide a system enabling motorists and others adjacent to the user, for instance on a dimly lit roadway, to detect and recognize the user.

Such an apparatus may illuminate the back of a user, such as, but not limited to, a bicyclist, motorized bicyclist or motorcyclist, walker, jogger, skier, snowboarder, or in-line skater.

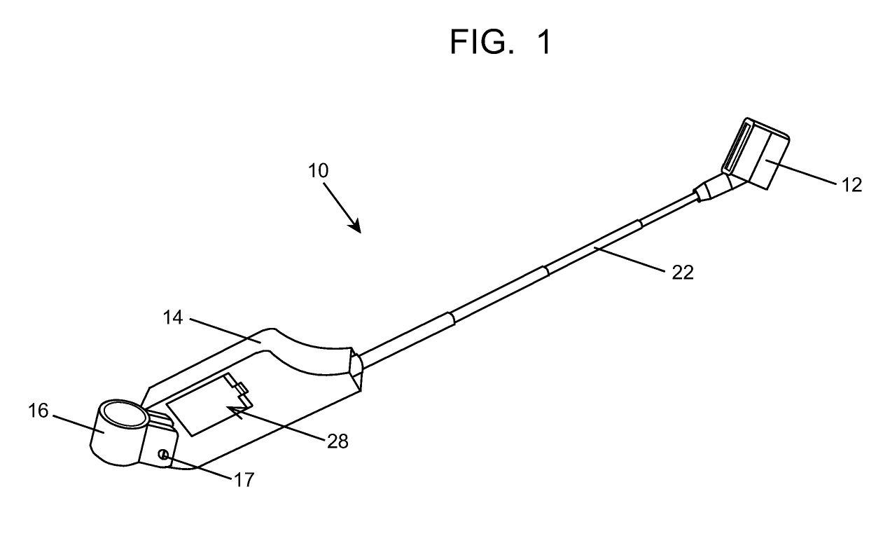

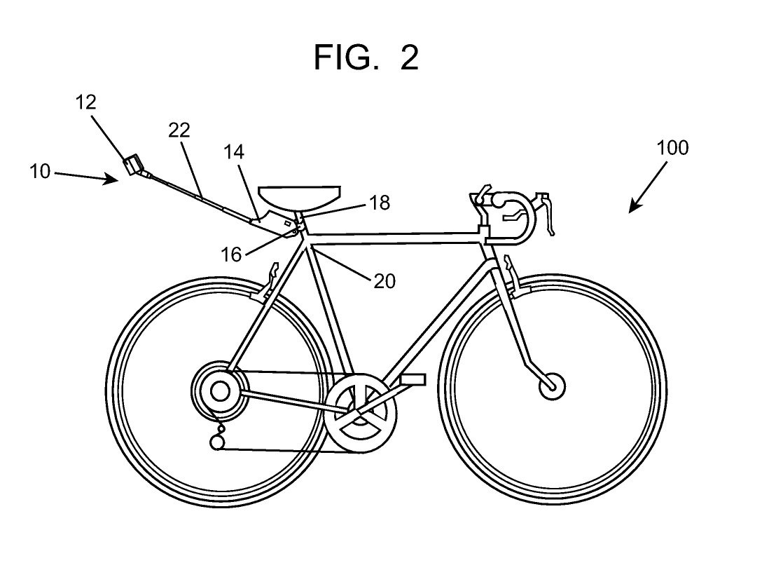

FIG. 1 is a perspective view of an exemplary embodiment of the lighting apparatus 10 of the present disclosure including a lamp housing 12 including bulbs (not shown) which is extended from a battery case 14 by a retracting/extending telescoping member 22. The battery case 14 may attach to a bicycle frame (see FIG. 2) or be attached to another piece of equipment or clothing. Accordingly, reference to a piece of equipment for attachment of the lighting apparatus may be understood as any equipment separate from the user (e.g. the bicycle frame) or a piece of equipment worn by the user (e.g. a vest or helmet or backpack) which may similarly support the lighting apparatus. Also shown is a battery access door 28 for batteries to power the lamp.

A clamp 16 may be used to attach the apparatus to a bicycle. The clamp 16 may include a knurled portion that may interface with a complementary knurled feature (not shown) on the outside of the battery case 14 to stabilize the angle at which the member 22 is articulated when extended. This makes attachment relatively easy, with a single hand-tightened bolt 17. The knurled feature may be part of an articulating joint that may allow the angle of the battery case 14 to be adjusted from nearly 0 to 180 degrees with respect to the orientation of the seat post 18. The clamp 16 also may allow the apparatus 10 to swivel almost completely about the axis of the seat post.

The retracting/extending telescoping member 22 is preferably a metal tube, so that it may be used as a portion of the electrical circuit supplying power to the lamp 12. As shown, the telescoping member 22 may be comprised of 5 interacting sections, preferably each of about 3 inches in length. It is contemplated that more or less sections of greater or less length may be used, depending on the length of extension desired and the length of the battery case 14 into which the member 22 retracts. Further it is contemplated that the retracting/extending member may be a folding mechanism or a flexible coilable cable.

As shown in FIG. 2, the lighting apparatus 10 may include a lamp housing 12 having bright lights (for instance, LED's), that may be extended several inches or even feet behind a rider on a bicycle 100 by utilizing the telescoping member 22, connected to a piece of equipment, such as a bicycle seat post 18 or frame 20 or bicycle rack on a bicycle. In other applications, such as for a skier, skater or runner, the apparatus 10 may be suitably attached to, for instance, a ski or ski boot, a snowboard, a skate or a belt, harness, hip-belt or backpack worn by the user. In those applications, the lamp housing 12 may be extended via the telescoping member 22 to a distance and at such an angle to provide illumination of a relatively large area of the user.

“Relatively large area of the user” as used herein refers to an area of the surface of the user, or area of the surface of the sporting equipment being used by the user, that is at least about 30% of the total area of such user or such equipment that is in line of sight of the light source. This relatively large area, such as the back or trunk of an individual, or frame of a bicycle, provides an improved lighted target that may be visible to, for instance, motorists approaching from the rear on a dark road.

“Line of sight” of the light source as used herein refers to the projected area of light emanating from light source at the distance of the user or subject from said light source.

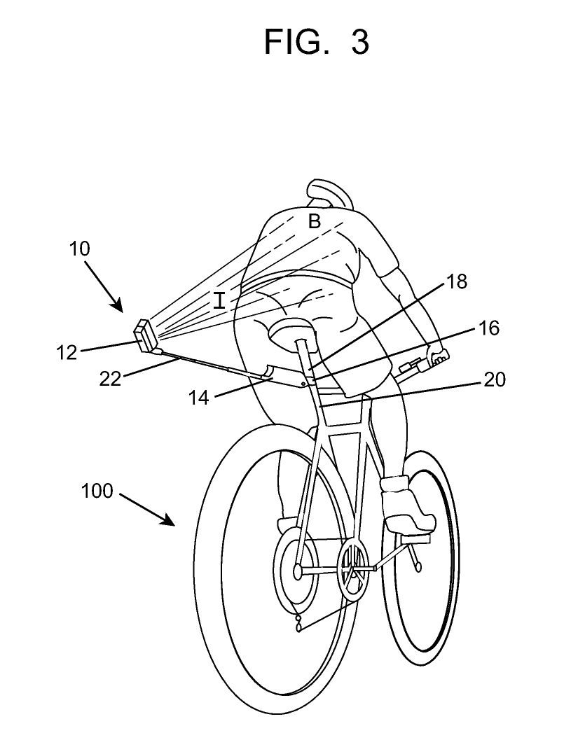

FIG. 3 is a perspective view of a rider on a bicycle 100 illustrating the illumination (rays of light I) provided by the lighting apparatus 10 when it is fully extended and angled to illuminate a relatively large area of the rider, such as his back B. While shown here as extended directly behind the rider, it is contemplated that the lighting apparatus 10 may be extended to one side (or the other) of the rider, preferably the left side, to illuminate a portion of the side of the rider in addition to his back, or to act as an “outrigger” to warn traffic from coming too close.

It is contemplated that the retractable/extendable member 22, preferably a telescoping tube may not be circular in cross-section but instead “sided” to prevent rotation of the lamp housing 12 relative to the battery housing 14. Accordingly, the cross-section of the telescoping tube may have a shape that includes but is not limited to, triangular, square, rectangular, pentangular, etc.

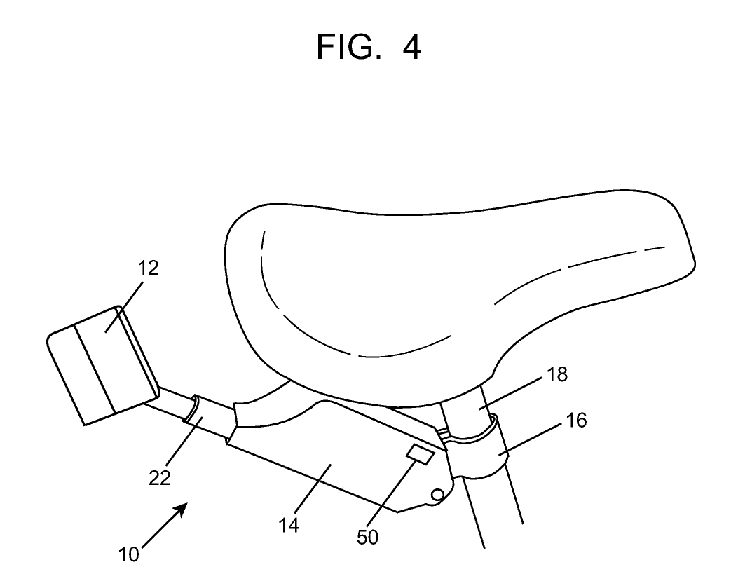

FIG. 4 is a side view of a portion of the bicycle 100 including the lighting apparatus 10 in a retracted position. It is contemplated that the telescoping member 22 may allow an extension, preferably of up to about 24 inches and that the apparatus 10 have an angle of articulation of about 45-135° with respect to the seat post and preferably greater than 90° from its stowed position. The range of extension may be 1.0 inch to 36.0 inches, in 0.10 inch increments.

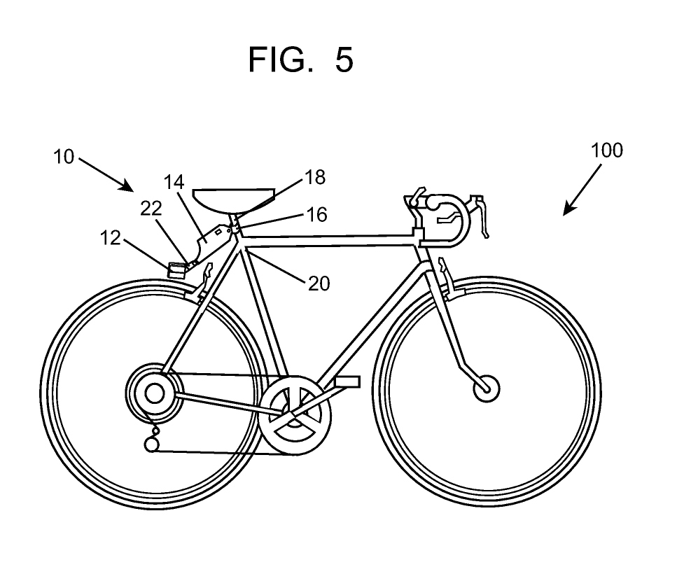

FIG. 5 is a side view of a portion of the bicycle including the lighting apparatus 10 in a stowed position behind and below the seat such that it does not interfere with mounting or dismounting the bicycle 100.

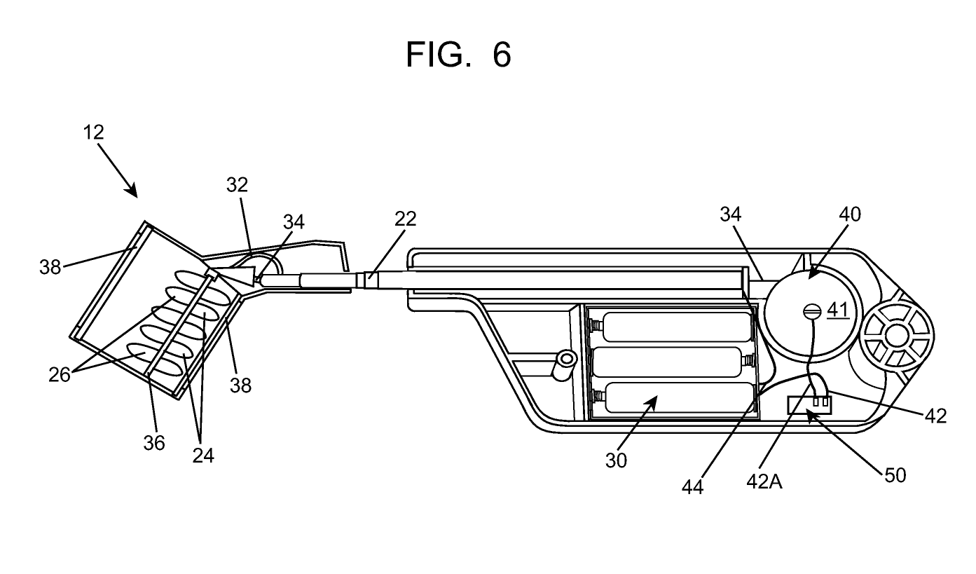

As shown in FIG. 6, the apparatus 10 may include a lamp housing 12 (cover removed for clarity of detail) which may include a plurality of white LED's 24 which direct light to a targeted area (for instance the trunk or back of a rider or runner), and preferably a plurality of red LED's 26 that are visible from the rear of the apparatus 10. In one exemplary embodiment, five-5 mm Super bright white LED's having a luminosity of intensity of 1500-18000 mcd have been found to provide an adequate amount of illumination on a rider. Other sizes, for instance, from 3 mm-10 mm may be used. The LED's may be mounted to a circuit board 36 and connected electrically to the outside of telescoping member 22 (as a ground) through a wire 32 and to retractor cable 34 which runs inside of telescoping member 22 to complete the power circuit. A clear plastic shield 38 may close out the ends of the housing 12 and seal out dirt and moisture.

The individual LED's may be angled over a variety of angles to provide maximum light illumination to over the area to be illuminated. Therefore, each LED may not illuminate the same location and the direction of maximum light emission for each LED may not be parallel.

FIG. 6 also shows a view of case 14 (with one side removed for clarity) that may house the battery pack 30 for powering the lamp 12, as well as the retracted telescoping member 22. The telescoping shaft may contain an electrically conductive wire or cable 34 that is isolated from the electrically conducting telescoping shaft. The case 14 may also house a retractor assembly 40 including a torsion spring and a spool 41 or pulley for wrapping the cable 34 that provides power to the lamp housing 12. The retractable cable 34 may run up the inside of the telescoping member 22 (see termination point in housing 12). The battery pack 30 may preferably include 3 ‘AAA’ batteries, although other sizes and numbers are contemplated. A positive wire 42A may run from the batteries to the switch 50 and another 42 to the retractor assembly 40. This may provide electrical contact to the cable 34 that runs up the center of the telescoping member 22 and which may be attached to the circuit board 36 in the lamp housing 12. Another wire 44 may connect the lower end of the telescoping member 22 with the negative terminals of the batteries.

Stated another way, the spool inside the retractor assembly 40 rotates and may be used to wrap the cable 34 as the telescoping member is retracted. Current flows via wire 42 from the batteries to the cable 34 that is attached at one end to the spool. The cable unwinds/extends as the telescoping member 22 is extended. The cable 34 is connected at the circuit board 36 to the LED's. The circuit is completed by wire 32 in the lamp housing 12 contacting the outside of the telescoping member 22. The current passes through the telescoping member and is connected via wire 22 to the negative terminals of the batteries.

It is contemplated that the cable 34 may be replaced by a fiber optic cable which may transmit light directly to the lamp housing 12 and that the light may be provided by a laser.

It is also contemplated that the power for the apparatus 10 may be generated by the mechanical action from the device on which it is mounted (bicycle, human, roller blades, etc.) and that such mechanical action (wheels turning, pedaling/running) may be converted via a generator to power the bulbs, LED's, etc.

The lighting apparatus 10 may provide a device capable of housing super-bright light-emitting diodes (LED's), which can be powered by a small battery pack attached at the base of the device or even within the light housing, or by a rotational generator in mechanical communication with a bicycle tire, skate wheel, or other mechanical component.

The lighting apparatus 10 may also provide a means of illuminating a body in distinct illumination patterns, characters, text or colors and wavelengths of light as well as with time-varying colors and intensity of light. The lighting apparatus 10 may provide a means of warning others of danger to or presence of the user by flashing a stationary or rotating light. It is further contemplated that some of the LED's may be of a color that indicates the type of user, in other words the rearward facing LED's 26 may be blue for a policeman, or yellow for a highway worker.

The lighting apparatus 10 may also be used to accentuate the presence of the user by shining light on reflective components on the equipment on which the user is riding wherein a reflective body may be attached, emblazoned, or otherwise integrated on the clothing or protective gear (e.g. helmet) of the user.

Instead of the telescoping member to provide extension and articulation of the lamp, the apparatus 10 may include a flexible bendable stem for easy storage when not in use or a foldable member that may store within the battery case.

The lighting apparatus 10 may be sold as an after-market product to improve the safety of existing products such as bicycles, and may be manufactured using traditional materials, such as plastics, metals, light bulbs, electronic components, fiber optic cables, and LEDs.

The lighting apparatus 10 further may provide a means to transmit electrical power to lights or other electrical devices through an electrically conductive cable or flexible polymer wire (or wires) that may be contained within a telescoping shaft or flexible shaft and in particular an electrically conductive telescoping shaft.

Further, the lighting apparatus 10 may provide a means to transmit electrical power to lights or other electrical devices or transmit light waves by using a retractor assembly including a spring loaded spool that can be used to coil the electrically conducting wire or cable or fiber optic cable used to transfer the electricity within the telescoping shaft.

In addition, the lighting apparatus 10 may use electromagnetic or light waves for power transmission within a fixed, flexible, or telescoping shaft.

Two aspects of bicycle safety when riding at night are detection and recognition. A rear facing red light may warn approaching motorists of the location of a cyclist. This may allow drivers the ability to detect a bicycle (provided their view is not obstructed by another vehicle, rider, etc.), however the rear facing lights may not help a driver recognize the subject as a bicycle rider. The small point illumination and low mounting of existing lighting products does not adequately address the problem. Motorists may not be able to discriminate a rear facing bicycle light from an illuminating toy, stationary reflector, keychain, or anything containing a red light. Further, this rear-facing product only shines in the reverse direction, that is, away from the subject. In the case of a vehicle approaching from the side or from a sharp angle (such as a turn in the road or pulling on to another road), such a light can easily be missed. It is in this situation that many accidents occur and for which the present disclosure is intended.

It has been found that the lighting apparatus of the present disclosure is superior in illuminating a bicycle rider. This lighting apparatus may make the rider more readily identifiable. Particularly at a distance, for instance of 50 yards, this lighting apparatus outshines current leading products. The greater brightness may allow motorists to more quickly identify the cyclist, or runner, and prevent an incident that could lead to serious injury.

These and further objects and advantages of the present invention may become obvious to one who reviews the present specification and drawings but also to those who may have an opportunity to experience an embodiment of the apparatus and methods disclosed herein. However, it may be appreciated that, although the accomplishment of each of the foregoing objects in a single embodiment of the invention may be possible and indeed preferred, not all embodiments will seek or need to accomplish each and every potential advantage and function. Nonetheless, all such embodiments should be considered within the scope of the present disclosure.

Furthermore, while this invention has been particularly shown and described with references to preferred embodiments thereof, it will be understood by those skilled in the art that various changes in form and details may be made therein without departing from the scope of the invention encompassed by the appended claims.

What is claimed is:

1. An apparatus for illuminating a human, the apparatus comprising:
a retractable/extendable member having ends;
a housing connected to a first end of said member, said housing including one or more light sources which illuminate an area;
a power supply for supplying electrical power connected to said member, said power supply in electrical communication with said one or more light sources;
wherein said human has a direction of movement and said member extends opposite the direction of movement of the human and wherein said light shines in the direction of movement and illuminates an area of the human.

2. The apparatus of claim 1 wherein said retractable/extendable member is a hollow telescoping tube.

3. The apparatus of claim 2 further including an electrically conductive cable or flexible polymer wire or multiple wires or cables contained within said telescoping tube, said cables or wires capable of transmitting said electrical power to said one or more light sources from said power supply.

4. The apparatus of claim 1 wherein said one or more light sources include light-emitting diodes.

5. The apparatus of claim 1 wherein a second end of said retractable/extendable member is connected to a bicycle, said bicycle having a seat post.

6. The apparatus of claim 5 wherein said second end further includes a second housing, said second housing including said power supply and further including a retractor assembly including an electrically conductive retractor cable.

7. The apparatus of claim 6 wherein said power supply, said retractor cable, said one or more light sources and said retractable/extendable member complete an electrical circuit for providing said illumination.

8. The apparatus of claim 5 wherein said second housing further includes at least a portion of an adjustable angle mechanism whereby said first end of said apparatus is adjustable from an angle of 45-135° with respect to said seat post.

9. The apparatus of claim 1 wherein said retractable/extendable member is flexible or foldable.

10. The apparatus of claim 1 wherein said one or more light sources are directed in multiple lighting directions.

11. The apparatus of claim 1 wherein said first housing is rotatable with respect to said retractable/extendable member.

12. The apparatus of claim 1 wherein said one or more light sources display certain patterns, characters, text, colors and wavelengths of light on said area of the human.

13. The apparatus of claim 6 wherein said retractor assembly includes a spring-loaded spool that coils said electrically conducting cable, said cable used to transfer the electricity within the telescoping tube.

14. The apparatus of claim 6 wherein said cable is fiber optic cable used to transfer light within the within the telescoping tube.

15. The apparatus of claim 1 wherein the power supply comprises an electric generator actuated by mechanical action.

16. The apparatus of claim 15 wherein the mechanical action can be pedaling, rolling or sliding.

17. The apparatus of claim 1 wherein the power supply comprises rechargeable batteries.

18. A method for illuminating a human or piece of equipment the method comprising:
providing an apparatus comprising a retractable/extendable member having ends;
a housing connected to a first end of said member, said housing including one or more light sources which illuminate an area;
a power supply for supplying electrical power connected to said member, said power supply in electrical communication with said one or more light sources;
wherein upon attachment of said apparatus to said piece of equipment and providing power to said apparatus said apparatus illuminates an area of said human and/or said piece of equipment.

19. The method of claim 18 wherein said retractable/extendable member is a hollow telescoping tube.

20. The method of claim 19 further including an electrically conductive cable or flexible polymer wire or multiple wires or cables contained within said telescoping tube, said cables or wires capable of transmitting said electrical power to said one or more light sources from said power supply.

21. The method of claim 18 wherein said one or more light sources include light-emitting diodes.

22. The method of claim 18 wherein said illuminated area comprises greater than 30% of the surface area of the human that is in line of sight to said one or more light sources.
